(19) United States
(12) Patent Application Publication
(10) Pub. No.: US 2002/0019312 A1
(43) Pub. Date: Feb. 14, 2002

(54) Glow-in-the-dark sublimation-receptive medium and method of making

(76) Inventor: Paul A. Ramsden, Boynton Beach, FL (US)

Correspondence Address: SWIDLER BERLIN SHEREFF FRIEDMAN, LLP, 3000 K STREET, NW, BOX IP, WASHINGTON, DC, 20007, US

(21) Appl. No.: 09/919,841

(22) Filed: Aug. 2, 2001

Related U.S. Application Data
(60) Provisional application No. 60/222,803, filed on Aug. 3, 2000.

(51) Int. Cl. B41M 5/035; B41M 5/38

(52) U.S. Cl. 503/227

(57) ABSTRACT

An image receptive medium including a substrate, at least one visible light producing layer arranged on the substrate and an image receiving layer arranged on the light producing layer and operable to receive an image through at least one of sublimation and diffusion.

### RELATED APPLICATIONS

This application claims priority from U.S. provisional application No. 60/222,803, to Ramsden, filed Aug. 3, 2000, the entire contents of the disclosure of which is hereby incorporated by reference.

### FIELD OF THE INVENTION

The present invention relates to an image receptive medium that produces visible light through phosphorescence and/or fluorescence. The present invention also relates to an imaging system that includes the image receptive medium, a method of making the image receptive medium, and a process for producing an image that includes utilizing the image receptive medium.

### BACKGROUND OF THE INVENTION

U.S. Pat. No. 5,270,100 to Giglio discloses the use of a phosphorescent substrate to which there is applied a translucent color material so as to permit the user to observe the color of the translucent material in the substrate in the dark.

U.S. Pat. 6,071,855 to Patton et al. discloses improvements to the system suggested therein by affording the user greater ability to modify, correct and store images to be printed onto the material, and improved the economic efficiency of personalized phosphorescent decoration.

Sublimation, in the context applied in the art of decoration by transfer printing, was developed in the late 1950's. The first recorded patent relating to the art was French patent no. 1,223,330. Since this time the commercial application has grown steadily although only in the last fifteen years, and more specifically the last five years, has this multi-faceted industry seen considerable growth, this more recently due in part to improved techniques, equipment, materials and formulations.

Sublimation decoration requires that dispersible dyes or pigments are deposited upon a transfer medium by a printing device, typically ink jet, bubble jet, laser, offset press or other means, the selection of which would be well known to those of average skill in the art. The printing device reproduces a digital image, usually comprising of a mirrored reflection of the stored digital-graphic file, disposed upon a transfer medium, which usually comprises paper. A mirrored orientation is typical due to the transfer-medium being necessarily applied face down onto the receptive-medium when subliming it into the receptive medium. This step creates a second switch in orientation, reproducing the original view upon the medium. One exception to this procedure is when the image is going to be viewed through the medium to which it is applied, such as might apply to sublimated glass. In this case the user of the art may select not to reverse the digital file.

Succeeding transfer of the sublimation dyes or pigments to the transfer medium, the medium is applied, imaged side down, onto a substrate or coated substrate that is able to accept the transfer of the image by sublimation or diffusion. This is generally undertaken by applying heat or pressure, typically both, to the material and transfer medium. In doing so the dispersible dyes or pigments are excited into gaseous state upon which they migrate into the adjoining receptive medium.

Sublimation dyes and pigments are, to a varying degree, translucent. It is common knowledge in the art of sublimation, that if an image is sublimed onto a dark surface then said image will likely appear darker and less colorful than in its original state. This is because light passing through the imaged layer is being absorbed not reflected and therefore offers little illumination of the sublimed layer. This relationship can be compared to a photographic slide which when viewed upon a dark background provides a barely visible image, becoming clearly evident however when viewed upon a bright or reflective base, or when some other form of back lighting is present.

Prior disclosures detail a method of enhancement of sublimed image clarity by a bright or reflective layer being positioned behind the sublimation-receptive layer. In this regard Sherman et al. in U.S. Pat. No. 5,856,267 state that the base coat ideally “ . . . has a pigment such as titanium dioxide within it to provide a solid color background for printing.” Additionally, Poole, in U.S. Pat. No. 5,962,368, state, “Before application of the coating into which the sublimation ink decoration will be imprinted, a white base coat background may be pre-applied to reflect the sublimation ink color or decoration.”

Sherman et al., in U.S. Pat. No. 5,976,296, states that, “The surface of the object to be printed preferably comprises a base coat and a top coat . . . .” Sherman et al. further suggest in reference to the base coat, “[P]referably it is pigmented with, for example, titanium dioxide in order to provide a solid color background for printing.” O'Brien, III, in U.S. Pat. No. 6,004,900, suggests integrating the reflective element into the sublimation-receptive coating. In particular, O'Brien III states that, “[A]n outer layer of the article . . . that includes an effective amount of an optically light pigment.” Additionally, O'Brien states that, “[T]he pigment can be or include titanium dioxide.”

Most transfer printing that embeds an image or design into a receptive medium is accomplished using sublimation techniques. However transfer printing also includes a melt printing process described in several patents and patent applications including U.S. Pat. No. 4,587,155 to Durand; U.S. Pat. No. 4,670,084 to Durand; U.S. Pat. No. 4,668,239 to Durand; and International patent publication WO 92/21514. According to U.S. Pat. No. 4,587,155, to Durand, the image is embedded into the receiving layer by heating a dye to a temperature above the melting point but below its vaporization temperature so the dye will diffuse into the softened plastic substrate.

Co-extruded zinc sulfide chemistries have for considerable time been the prior art recommendation for phosphorescent pigmentation. U.S. Pat. No. 5,965,242 to Patton et al. discloses “a phosphorescent pigment, such as copper-doped zinc sulfide.” Also, U.S. Pat. No. 5,998,525 to Wang et al. describes “pigments based on zinc sulfide.”

### SUMMARY OF THE INVENTION

The present invention provides an image receptive medium that includes a substrate. At least one visible light-producing layer is arranged on the substrate and produce visible light through at least one of phosphorescence and fluorescence. An image receptive layer is arranged on the visible light-producing layer and is operable to receive an image through at least one of sublimation and diffusion.

Additionally, the present invention provides an imaging system that includes an image receptive medium that includes a substrate, at least one visible light-producing layer is arranged on the substrate and produces visible light through at least one of phosphorescence and fluorescence, and an image-receiving layer arranged on the visible light producing layer operable to receive an image through at least one of sublimation and diffusion. The system also includes a transfer medium comprising an image to be transferred to the image receptive medium by at least one of sublimation and diffusion.

Also, the present invention provides an imaging system. The imaging system includes a processor operable to modify an image and to transmit the image to a printer. The system also includes a printer operable to receive the image and print the image on a transfer medium. A transfer device is operable to apply at least one of heat and pressure to the transfer medium and an image receptive medium to effect transfer of the image from the transfer medium to the image receptive medium through at least one of sublimation and diffusion.

Furthermore, the present invention provides a method of making an image receptive material. The method includes depositing at least one visible light-producing layer arranged on a substrate. The visible light-producing layer producing visible light through at least one of phosphorescence and fluorescence. An image receptive layer is deposited on the light-producing layer. The image receptive layer is operable to receive an image through at least one of sublimation and diffusion.

Still further, the present invention provides a process for producing an image on an image receptive medium that includes at least one visible light-producing layer that produces visible light through at least one of phosphorescence and fluorescence and an image receptive layer arranged on the light producing layer and operable to receive an image through at least one of sublimation and diffusion. The process includes altering a digital representation of an image perform at least one compensating for and complementing a hue of visible light produced by the visible light-producing layer. The altered image is formed on a transfer medium. The image is transferred from the transfer medium to the image receptive medium.

Still other objects and advantages of the present invention will become readily apparent to those skilled in the art from the following detailed description, wherein it is shown and described only the preferred embodiments of the invention, simply by way of illustration of the best mode contemplated of carrying out the invention. As will be realized, the invention is capable of other and different embodiments and its several details are capable of modifications in various obvious respects, without departing from the invention. Accordingly, the drawings and description are to be regarded as illustrative in nature and not as restrictive.

### BRIEF DESCRIPTION OF THE DRAWINGS

Objects, advantages, and features of the present invention will be more clearly understood from the following description when considered in conjunction with the accompanying drawings, in which:

FIG. 1 represents a perspective cross-sectional view of an embodiment of an image receptive medium according to the present invention;

FIG. 2 represents a cross-sectional view of the embodiment of the image receptive medium shown in FIG. 1;

FIG. 3 represents a cross-sectional view of another embodiment of an image receptive medium according to the present invention, which includes a protective surface layer;

FIG. 4 represents a cross-sectional view of the embodiment of the image receptive medium shown in FIGS. 1 and 2 with an image transfer medium applied onto the image receiving medium prior to image transfer;

FIG. 5 represents a cross-sectional view of the embodiment shown in FIG. 4, after carrying out the image transfer; and

FIG. 6 represents an embodiment of an imaging system according to the present invention.

### DETAILED DESCRIPTION OF THE INVENTION

While some processes and structures exist for producing what might be described as self-illuminating graphics, these processes and structures suffer from shortcomings. For example, U.S. Pat. No. 6,071,855 to Patton et al. includes process requirements that restrict the function and capacity of the self-illuminating graphics disclosed therein. These restrictions include the limited selection of materials compatible with the coating and imaging system disclosed by Patton et al. For example, Patton et al. presents only a method of applying images to media capable of accepting said images directly “from a digital printer.” Additionally, Patton et al. requires that the image be printed directly onto the substrate surface. Patton et al. also states that it is a necessity to provide “a protective coating over said receiving layer” to produce a finish of acceptable durability.

As will be borne out by the discussion below, in contrast to the present invention, Patton et al. requires that the medium pass through a printing device in order that dyes or pigments may be printed directly upon the surface of the medium. Accordingly, the substrate must be flat, thin, flexible, light and fall within the media dimension handling capacity of the printing device. This requirement limits the selection of substrates compatible with the system and, thus, restricts the capacity and functionality of the process disclosed by Patton et al. The referenced invention therefore excludes substrates such as ceramic or stone tiles, formed or contoured materials, glass, or any other substrate otherwise too heavy, including an uneven surface or otherwise not compatible with typical imprinting devices.

Patton et al. also requires that following decoration, the imaged medium be subject to additional coating application(s) in order that the decorated surface is able to withstand everyday wear and tear. This final step of the process eliminates the possibility for most home or small business users of digital imaging equipment to place customized images onto glow-in-the-dark blank substrates. Without this essential step the imprint produced according to Patton et al. would easily wear out, be scratched, fade, or endure some other inevitable fate.

It would be advantageous if users of such imaging techniques could apply graphics to a multitude of substrates, capable of glowing in the dark, without the need for applying subsequent coatings requiring additional skills, equipment, workspace and in some cases permits to operate. The digital and imaging equipment required to sublimate or diffuse colors and designs into pre-coated receptive substrates is becoming increasingly popular both commercially and domestically, due in part to an increasing diversity of suitable materials and applications to which the technology may be applied.

In contrast to the weaknesses discussed, the present invention provides an alternative glow-in-the-dark medium and presents the optimal method of applying graphics thereto. The present invention increases the diversity of materials that can be coated and imaged with phosphorescent and/or fluorescent properties, further increasing the body of persons and entities, both skilled and unskilled in related coating arts, that stand to use and benefit by this method of custom graphics application. Some embodiments of the present invention provide a system that is highly environmentally compliant, employing powder coating technology and radiant energy curing systems, while providing durability and highest performance of the medium following the application of the image. This is achieved without the need for additional protective layers. The present invention can employ water-based or solvent-based chemistries.

As would be well known to those skilled in the coating arts, compatible coatings may comprise a plurality of chemistries, produced and applied in powder or liquid form, by electrostatic means or otherwise. These coatings, chemistries and processes are compatible with the present invention. One example of intended use of the present invention includes glow-in-the-dark safety-enhancing devices including signage.

The present invention is an improvement to the functionality of glow-in-the-dark chemistry and the art of sublimation transfer printing. Along these lines, the present invention introduces a multi-capable method of illuminating sublimed or diffused graphics by disposing them upon a device that is capable of glowing-in-the-dark. The luminescent base layers preferably comprise of a phosphorescent pigmentation, hereafter also referred to as a glow-pigment, which provides for the self-illumination of the graphic layer disposed upon it. Not only does this invention enable graphics to be visible in the dark it also enhances said visibility in fading or subdued lighting. The present invention includes the option to substitute or supplement the phosphorescent pigmentation for other luminous pigmentation according to the object or function of the final medium.

In general, the present invention provides an imaging medium. The medium includes a substrate. At least one visible light-producing layer arranged on the substrate. The visible light-producing layer produces visible light through phosphorescence and/or luminescence. An image-receiving layer is arranged on the light-producing layer. The image-receiving layer receives an image through sublimation and/or diffusion of dyes and/or pigments from a transfer medium.

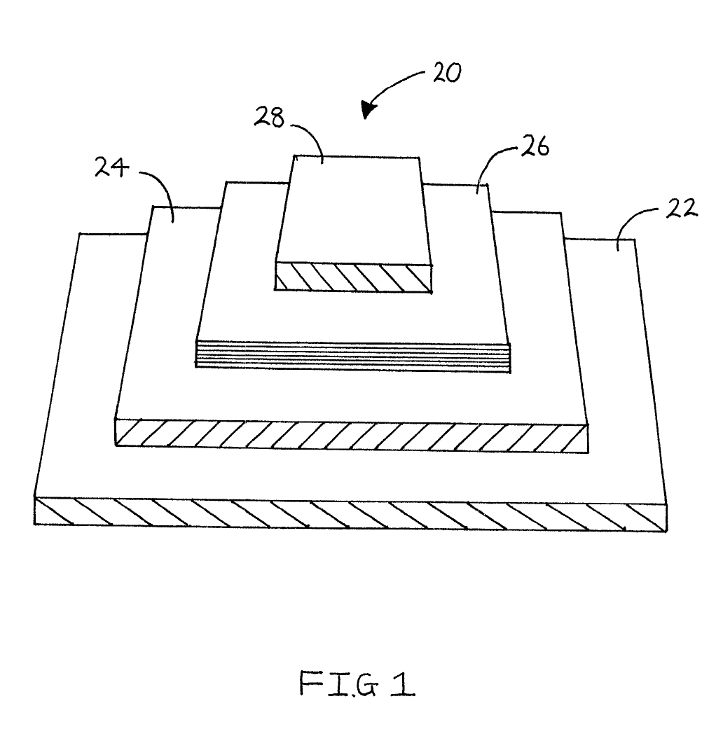

FIG. 1 illustrates a perspective and cross-sectional view of an embodiment of an image receiving medium 20 according to the present invention. This embodiment is a glow-in-the-dark sublimation-receptive imaging medium 20. The medium 20 includes a support substrate 22. The embodiment of the substrate 22 shown in FIG. 1 is sheet aluminum.

In general, any substrate may be utilized according to the present invention. For example, any metal, alloy, ceramic, plastic, or fibrous material may be utilized as a substrate. Aluminum represents just one example of a metal substrate material. Examples of ceramics include glass and porcelain. Fibrous substrates could include wood or paper. Those skilled in the arts of coating and sublimation well know that a plurality of substrates may be considered suitable supportive base materials and would be able to determine additional substrates with out undue experimentation.

Some substrates are dark and/or inadequately reflective to produce a desired degree of visibility of the image transferred to the imaging medium. In some cases, if the reflectivity of the substrate falls below a certain threshold value, at least one base layer may be utilized. This could be the case where the present invention is utilized for signage, which may have requirements for visibility.

In embodiments where a base layer is utilized, a light colored and/or highly reflective base material may be applied to the substrate. The light colored and/or reflective base material can help to achieve high clarity, color accuracy and visibility of an image formed thereon. The light or reflective base can also assist in reflecting light to excite the phosphorescent and/or fluorescent layer(s) and imaged layer disposed over the base layer. Suitable base coatings may include any durable pigmented material. According to one example, the base layer is white. The white base layer can include a titanium dioxide pigmented polyester powder coating. Such a coating is available from many suppliers. One particular example is Morton Traffic White TGIC Polyester powder coating. Other examples of base layers include light-colored inorganic pigmented glaze fired onto ceramic or glass, enamel coatings, and liquid organic polymer coatings with light colored or reflective pigmentation. Typically, a base coating will have a reflectivity sufficient to illuminate typical sublimed or diffused colorants embedded within layers applied thereto. The chemistries, application, techniques, sources, and handling of base coatings, including those listed above, are well known and common to those skilled in the art.

Certain substrates require the application of one or more priming layers either to improve the deposition of the base coating to the substrate or induce or improve a chemical reaction between the base coating and substrate during a cure cycle. Such primers typically are liquid-based primers. Such primers are know to those of ordinary skill in the art, who would be able to determine a suitable primer without undue experimentation once aware of the disclosure contained herein.

However, it is not necessary that embodiments that include a base layer include a primer. For example, metal substrates may be coated using electrostatic powder deposition. Such a deposition technique generally applies an even and well adhering coating without the use of a priming layer. The embodiment shown in FIG. 1 includes base layer 24 on the aluminum substrate.

Over the substrate or the base layer, at least one light-producing layer may be applied. The light-producing layer may absorb energy from the electromagnetic spectrum including, but not limited to, ultraviolet, visible, infrared wavelengths and/or any other wavelength. The light-producing layer(s) may produce light in various portions of the electromagnetic spectrum. However, at least a portion of the light produced by the light-producing layer(s) typically includes visible light. The light-producing layer(s) serves to illuminate graphics sublimed or diffused into an image receptive layer described below. This fluorescent illumination enables graphics to be illuminated in the dark after activation with ambient light or ultraviolet or black light source.

Typically, the light-producing layer(s) produces light through phosphorescence and/or fluorescence. Any phosphorescent and/or fluorescent material could be utilized. Examples of phosphorescent materials include alkaline phosphorescent materials. One particular alkaline phosphorescent material is strontium aluminate. The phosphorescent materials, such as strontium aluminate, are typically activated by rare earth ions. Other fluorescent and/or phosphorescent materials could also be utilized. Those of ordinary skill in the art would be able to determine other suitable fluorescent and/or phosphorescent materials without undue experimentation once aware of the disclosure contained herein.

The phosphorescent and/or luminescent materials may be mixed with at least one transparent and/or translucent material. The material can serve to carry, disperse, and/or suspend the pigment to facilitate use, stability, and/or permanence of the pigment. The pigment is suspended, carried and/or dispersed in a similar manner to the way in which an inorganic pigment is carried by an organic, or hybrid. coating. The transparent and/or translucent material(s) can include one or more polymers that are clear upon curing.

Examples of a suitable family of polymers include both organic and inorganic chemistries. Examples of inorganic chemistries include chemistries associated with fired glazes applied to ceramics. Typically, due to factors such as time, cost, environmental impact, and/or application parameters associated with inorganic glaze application, a common form of polymer coating would employ organic polymers, typically including polyester and/or polyester hybrid chemistry. One example of a polymer is polyester. One specific example of a polyester includes Morton Corvel™ Clear TGIC Polyester. The phosphorescent and/or luminescent materials and possible transparent and/or translucent material(s) may have a similar chemistry to any base layer that may be utilized.

The phosphorescent and/or luminescent materials may be mixed with the translucent and/or transparent material prior to application on the base layer or substrate. The translucent and/or transparent material may be in the form of a powder. Various size particles of translucent and/or transparent material may be utilized. Those of ordinary skill in the art, one aware of the disclosure contained herein, would be able to determine particle sizes, and other parameters for the material without undue experimentation. One factor that may be taken into account is end coating thickness requirements.

Where the phosphorescent and/or fluorescent material and translucent and/or transparent material are both in the form of a powder, both materials may have similar or varied particle sizes, which may assist in dispersion and application. Typically, thin film coatings will employ a pigment particulate larger than the powder. Likewise, thicker films may employ a pigment particulate smaller than the host polymer. Those of ordinary skill in the art would be able to determine appropriate particle sizes without undue experimentation once aware of the disclosure contained herein.

The translucent and/or transparent material may also be in the form of a liquid. Additionally, various relative amounts of the phosphorescent and/or fluorescent material and translucent and/or transparent material may be combined. Furthermore, various methods may be utilized to combine the materials.

According to one embodiment, phosphorescent and/or fluorescent pigment is mixed and typically not extruded with a clear polyester powder coating. The pigment and polyester may be mixed in a weight ratio of about 1:2 to about 1:20 (phosphorescent and/or fluorescent pigment: clear coating). One particular embodiment employs a weight ratio of about 1:4 of phosphorescent and/or fluorescent pigment to clear carrier coating.

The reason that phosphorescent and/or fluorescent pigments typically are not extruded is that the phosphorescent capability of such materials may be reduced following or under influences of extreme or constant heat, impact or shear, and therefore does not perform as brightly, or for as long, following extrusion, grinding or milling. Therefore, according to the present invention a granulated glow-pigment may be mixed within a suitable host coating without extrusion, grinding or milling. The coating may then be applied in multiple thin layers. Typically, greater film thickness can be achieved by applying multiple layers as opposed to one single layer, notwithstanding that for many applications, one coating will suffice, assume that the ratio of content of pigment, clarity of carrier polymer and thickness of coating permits. This combined preparatory stage produces superior brightness and duration of glow compared to techniques disclosed prior hereto.

Whether or not combined with a translucent and/or transparent material, a plurality of layers of phosphorescent and/or fluorescent material may be included in the imaging medium of the present invention. The phosphorescent and/or fluorescent layers may vary in thickness. However, multiple thin layers may provide more favorable results than a single thick layer. If a thick layer is desired, it can be achieved utilizing multiple layers. Typically, the thickness of a layer will vary between about 0.01 mm and about 1.00 mm although it is feasible that considerably thinner and thicker layers may be successfully employed without straying from the theme of this invention. Slightly under curing each intermediate layer can improve bonding, adhesion, and, in some cases, fusion between the coating layer, as is known to those of ordinary skill in the art.

In the embodiment shown in FIG. 1, a total of six phosphorescent layers 26 have been applied with an individual layer thickness of about 0.2 mm to about 2.0. According to one specific embodiment, each layer has a thickness of about 0.2 mm. In embodiment shown in FIG. 1, the phosphorescent pigment has been mixed and not co-extruded with a clear polymer that carries it.

Typically, any material deposited on the luminescent layer is preferably substantially translucent or transparent and permits light to penetrate sub-layers within the coating, activating the phosphorescent layers disposed underneath the image-receptive surface. This includes any of the layers described below. This permits energy stored in the luminescent layer to be released as phosphorescent light illuminates the translucent sublimed pigments or dyes disposed thereon.

An imaging medium according to the present invention may also include a protective layer to inhibit penetration of moisture or other instability potential within the matrix of the phosphorescent pigmented layer. Other negatives of mixing solid dry-blended pigmentation with coatings without sealing include permeation of moisture or chemicals that may find their way into the matrix through the unsealed surface. Therefore, alongside moisture, other chemical or physical penetration by solids, liquids, or gasses considered harmful to the stability of the matrix are resisted by the application of a top coat that seals the surface. The protective layer may be deposited at any location in the medium, but typically is arranged on top of the light-producing layer. The protective layer may be arranged directly on the light-producing layer. The protective layer may be deposited utilizing any suitable technique. According to one embodiment, the protective layer includes an extruded coating.

At least one image-receiving layer is contained within or is arranged over the light-producing layer. The image-receiving layer(s) receives dyes or pigments thorough sublimation and/or diffusion. In some embodiments, the image-receiving layer acts as the protective layer referred to above. Any sublimation/diffusion receptive material may be utilized. Typically, the image-receiving layer(s) is transparent or translucent. Graphics typically in the form of dyes and/or pigments may be sublimed or diffused into the image-receiving layer by techniques well known to those skilled in the art of sublimation decoration. One example of a material suitable for sublimation imaging is SUBLI-COAT™, commercially available from RADCOAT SYSTEMS™. Other examples include U.S. Photo Coating available from U.S. Photo and Sublimation Coating. The image-receiving material utilized typically includes organic polyester-based chemistries. However, the image-receiving material may be tailored to the substrate, primers, dyes, intended applications and/or other factors. Those of ordinary skill in the art would be able to determine other image-receiving materials without undue experimentation once aware of the disclosure contained herein.

The thickness of the image receiving layer(s) may vary from about 0.1 mm to about 20 mm. More typically, the layer(s) have a thickness of about 0.2 mm to about 4 mm. The embodiment shown in FIG. 1 has one image-receiving layer 28 having a thickness of about 1.0 mm.

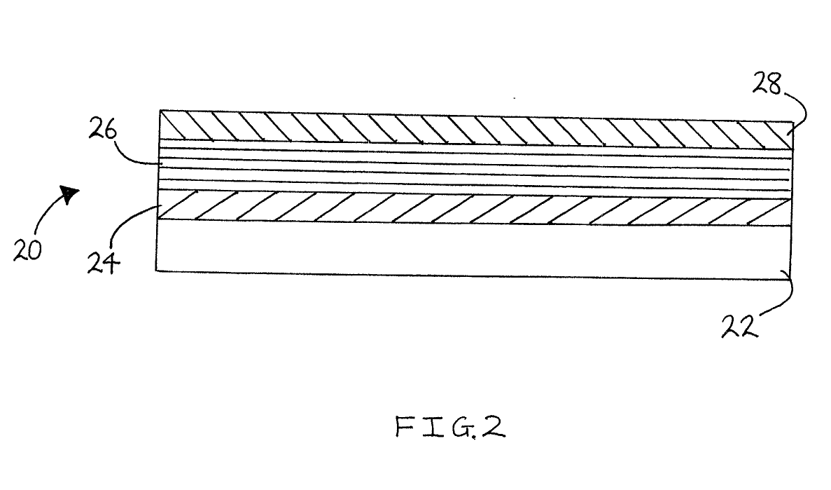

FIG. 2 illustrates a cross-sectional view of the embodiment of the sublimation receptive medium shown in FIG. 1. Similar to FIG. 1, FIG. 2 illustrates a sequence of layers within the medium. In the embodiment shown in FIG. 2, the base substrate 22 illustrated has been coated with a titanium dioxide pigmented polyester-urethane powder coating layer 24, which was applied by electrostatic corona deposition and cured by medium wave infrared red energy. Those of ordinary skill in the art would be able to deposit and cure any of the materials described herein without undue experimentation.

The six phosphorescent layers 26 were applied upon the base coating 24. The sublimation receptive layer is applied upon the phosphorescent layers. Typically, the application of multiple-layered coatings may be aided by partially under curing each layer as applied to enhance fusion of the subsequently applied layer. Upon applying the sublimation-receptive layer 28 the complete coating should be fully cured to enable successful sublimation reception and reliable performance of the entire coating matrix.

Typically, the phosphorescent and/or fluorescent pigmentation should not be exposed to high heat kiln firing cones. However, the pigmentation is compatible with low heat kiln firing, such as on the order of about 1200° C. or less and typically is about 800° C. or less. The effects of overexposure to curing energy or reaction to other climatic conditions are similar to those experienced and known to those of ordinary skill in the art.

An imaging medium according to the present invention may include at least one protective layer arranged on the image-receiving layer(s). The protective layer(s) typically would be non-image receiving and would be transparent to permit an image underneath to be seen clearly. The protective layer(s) may include any material(s) to provide any functional protection. For example, the protective layer(s) could provide resistance to the effects of chlorine for applications in a swimming pool. Alternatively or additionally, the protective layer(s) could provide resistance to specific undesirable regions of the electromagnetic spectrum, including ultraviolet and/or infrared wavelengths. This could be particularly useful for applications of the present invention in which the final product will be exposed to sunlight. Typically, the protective layer(s) would be applied after transfer of the image to the image-receiving layer. The protective layer could also be formulated and applied to address other chemical and/or physical attacks on the imaging medium, such as temperature, abrasion, scratching, absorption of moisture, penetration of chemicals, and/or other attacks.

A protective layer(s) according to the present invention could include any suitable material. Examples include lacquer, polyester-urethanes, fluoropolymers, acrylics, polymer films, and/or other protective layers. Those of ordinary skill in the art could identify suitable materials without undue experimentation once aware of the disclosure contained herein. Typically, any protective layer typically should be sublimation resistant to inhibit migration of sublimed colorants, which may occur in some heat/pressure environments. The protective layer typically has a thickness of about 0.1 mm to about 1.0 mm. In some embodiments, the protective layer has a thickness of about 0.5 mm to about 5.0 mm.

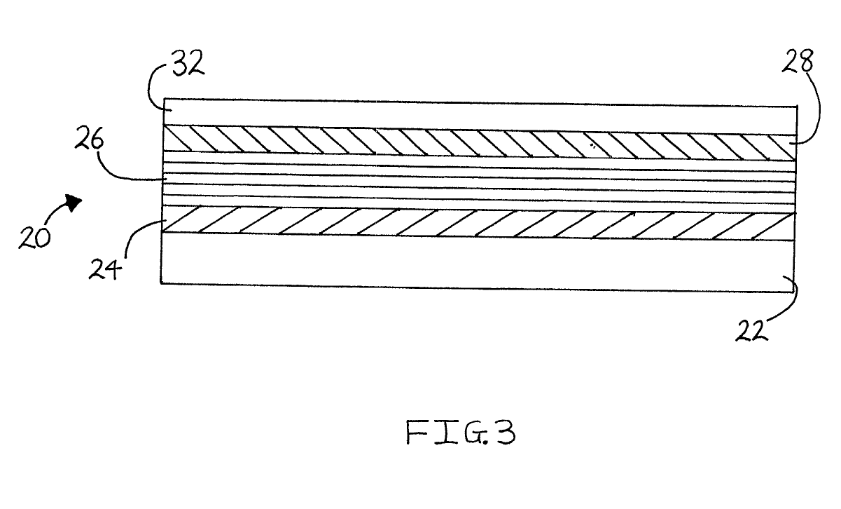

FIG. 3 illustrates a cross-sectional view of an embodiment of an imaging medium that includes a protective layer. The protective surface layer 32 represented in FIG. 3 is applied post sublimation transfer. This embodiment of a protective layer comprises the partially UV blocking fluoro-carbon polymer film TEDLAR, commercially available from DUPONT. Notwithstanding this layer 32 is optional as the sublimed or diffused pigmentation or dye is already contained within the matrix of the sublimation-receptive layer 28 and is protected by the ultraviolet absorption and chemical resistance properties of the host layer 28.

An imaging medium according to the present invention may also include at least one color-altering material to alter a color of an image produced on the medium. The color altering material(s) may be incorporated into any one of the layers described herein. For example, the color altering material could be incorporated into the luminescent light-producing layer and/or the image-receiving layer. Alternatively or additionally, the present invention could include a separate color-altering layer that includes one or more color altering materials.

The color-altering material(s) could include pigments or other materials that can alter the color of an image as it would otherwise appear on the imaging medium. The color altering material(s) may be utilized to complement or compensate for the hue of a phosphorescent glow. For example printing blue ink over yellow phosphorescent pigment will produce a lean towards green when viewed at night. Additionally, a color may be deliberately placed upon a corresponding color to register with optimal accuracy. It may also be desired to have an image appear in a false color.

Color-altering materials can include transparent and/or translucent pigmentation. The color-altering material may be inorganic for increased stability. The color-altering material can include inks, dyes, and other colorants sublimed, diffused, and/or otherwise imprinted on or contained within layers disposed thereon.

After forming the image-receiving medium, an image may be transferred to the image-receiving medium. The image is transferred from a transfer medium to the image-receiving medium. The transfer medium may be any transfer medium typically utilized in sublimation/diffusion printing. After placing the transfer medium in contact with the image-receiving medium, and, depending upon ambient climatic conditions, heat and/or pressure are applied to the transfer medium and the image-receiving medium.

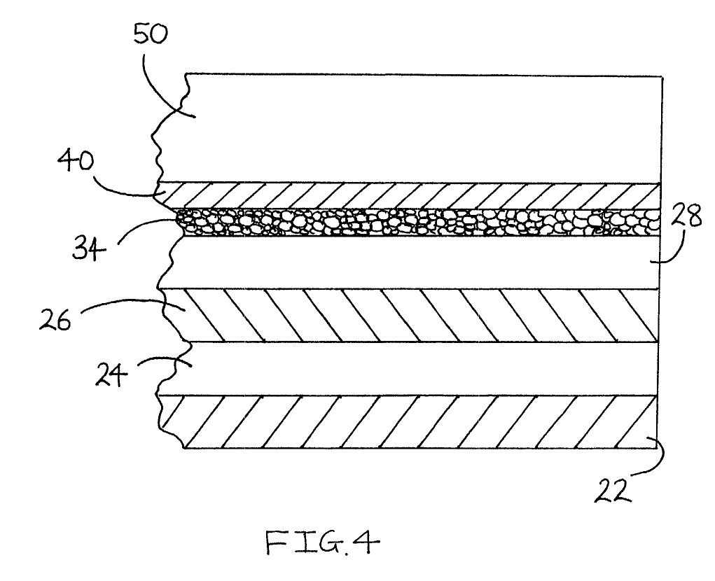

FIG. 4 illustrates a cross sectional view of the application of a platen 50 upon the transfer medium 40 including the sublimation and/or diffusion sensitive pigmentation and/or dyes 34. The platen induces pressure and/or heat necessary to induce sublimation of the pigmentation and/or dyes. Prior to sublimation the sublimation sensitive image 34 is affixed onto the sublimation transfer medium 40 having been applied to it by a printing device. The printing device utilized to apply the image can include any printing device. Examples of printing devices that may be utilized include inkjet, bubble-jet, laser, and offset web technologies.

The sublimation transfer medium typically includes paper specifically formulated to attach the pigmentation accurately and release it fully under influence of heat, pressure and time. This transfer medium 40 with attached pigmentation or dye 34 is applied face down onto the image-receptive layer 28. Utilizing the platen or other means, adequate pressure and heat are induced to result in migration of the pigmentation or dye from the transfer medium 40 into the receptive layer 28.

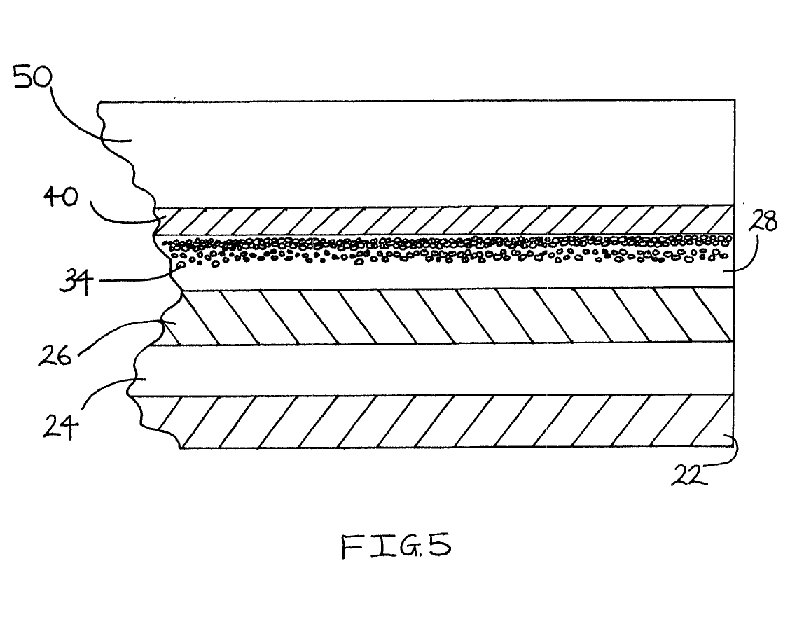

FIG. 5 illustrates a cross-sectional view of the structures shown in FIG. 4 post-sublimation. As is indicated, the sublimation pigmentation or dye 34 has migrated from the transfer medium and is now contained within the matrix of the image-receptive layer 28. The depth to which the pigment or dye 34 migrates into the image-receptive layer 28 depends upon the pigmentation or dye formulation, the receptive polymer formulation and the duration and settings of heat and pressure applied to effect the sublimation-transfer. Typically, lighter pressures, lower heat, and less heat/pressure times of application reduce the depth of penetration of sublimed or diffused colorants. Penetration can be increased, in some cases exponentially, when various factors are optimized in combination. For example, higher heat, greater pressure, and/or longer application can be adjusted to create an environment most conducive to deepest colorant migration within the working parameters of the materials employed. Those of ordinary skill in the art would be able to adjust various parameters, including those discussed above, to achieve a desired degree of penetration without undue experimentation once aware of the disclosure contained herein.

The present invention also includes a process for producing an image on an image-receiving medium such as that described above. According to the process, a digital representation of an image is transferred to a transfer medium. The image is then transferred to the image-receiving medium. The method can include capturing the image. The image may be captured with a scanner, with a still or video camera, from a storage medium or may be created with a computer with or without input. In other words, an image created with a computer could include graphics generated with the computer and not including material from another source, such as previously stored on a storage medium or from a camera, scanner or other device.

Prior to being transferred to the transfer medium, the image may be altered to improve, adjust and/or enhance the image. The alterations may be carried out through manipulating a digital representation of the image with a computer. The alterations can carry out any of the functions described above that can be accomplished with coloring additives added to the image-receiving medium. One function that the alteration of the image can accomplish includes compensating for and/or complementing a hue of visible light produced by the visible light-producing layer. Another function that the alteration can accomplish includes optimizing the accuracy of the appearance of the image formed on the image-receiving medium. After alteration, the altered image may be transferred to the transfer medium and then to the image-receiving medium.

The present invention also includes an imaging system. The imaging system may include a processor operable to modify an image. The image modification may include any of the color modifications described herein, or any other modification, such as may be performed with commonly available image manipulation software.

The processor may be included in a computer that includes wired or wireless connections for transferring the image to a printer. The computer may also include one or more monitors for displaying the image. In addition, the processor may receive the image from any image source, such as those discussed herein. The image may be entirely created on the computer as well. The image source is operable to directly or indirectly transfer the image to the processor and/or a printer.

An imaging system according to the present invention may also include a printer operable to receive the image from a processor, computer and/or image source and print the image on a transfer medium for subsequent transfer to the imaging medium of the present invention. A system according to the present invention may also include a transfer device for transferring the image from the transfer medium to the image-receiving medium. The transfer device may include means for applying heat and/or pressure to the transfer medium and the image-receiving medium. The heat and/or pressure application means may include a platen. The platen may engage the transfer medium. Another platen or a surface may be arranged opposite the platen that engages the transfer medium.

The various elements of the system may be connected together with any wired or wireless connections. Any suitable printer and ink, pigment and/or dye may be utilized to reproduce the image on the transfer medium. The system may include a platen or other device to accomplish transfer of the image from the transfer medium to the image-receiving medium.

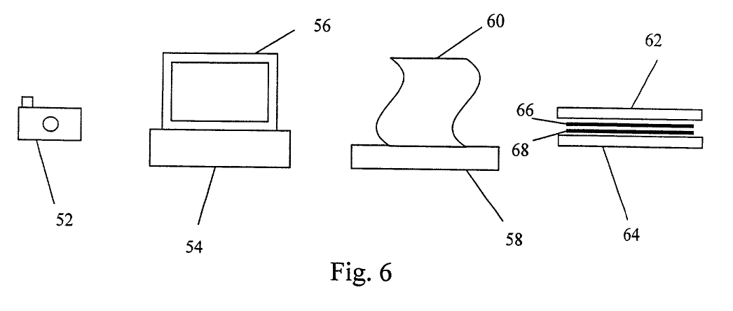

FIG. 6 illustrates an embodiment of a system according to the present invention. The system includes an image source 52. A computer 54 that includes a processor receives an image from the image source. A monitor 56 may display the image. The computer transfers the image to a printer 58, which prints the image on the transfer medium 60. A transfer medium 66 and image receiving medium 68 may be arranged between two platens 62 and 64 for application of heat and/or pressure. Platen 64 may also be just a surface against which platen 62 may apply pressure.

Advantages of the present invention includes providing a functional, durable and appealing coating opportunity, suitable for application to a plurality of substrates with the intention of fulfilling an equally diverse plurality of uses. The product according to the present invention is a safety enhancing decorative finish that stands to be welcomed by a wide array of industries and professionals.

Additionally, the medium of the present invention can include any size, shape or weight specification and may be useful in a plurality of applications not limited to decorative, protective, and/or safety and accident-preventative functionality. The coated medium may or may not be decorated by sublimation. Without additional protection the medium can withstand general use applications and wear and tear, as determined by the manufacturer of the coatings employed, and the skills of the applicator using prior art or improved techniques. With additional modification the medium can be adapted to harsh applications otherwise beyond the operable parameters of typical sublimation decoration, such as the extreme chlorine and ultraviolet exposure experience of exterior ceramic swimming pool murals.

Furthermore, the present invention can provide improved light storage and emission capacity of a phosphorescent coating. Along these lines, the present invention provides a process of preparing and applying a phosphorescent coating that performs for longer and brighter than typical chemistries employed or recommended in known processes and products. The present invention can also optimize enhancement of the light absorption efficiency and capacity of the cumulative phosphorescent layers. Subsequently, post-absorption, the coating is capable of greater duration and brightness of phosphorescent light emmittance in fading ambient light or darkness, thus producing a brighter and longer illumination of the sublimed or diffused graphics.

Also, the present invention can enhance the performance of an imaged glowing medium through two different techniques. In the first technique digital color registration may be altered to complement or compensate for the hue of the phosphorescent glow. For example printing blue ink over yellow phosphorescent pigment will produce a lean towards green when viewed at night. According to the second technique, the imaging medium may be altered by deliberately placing a color upon a corresponding color to register with optimal accuracy.

Still further, the present invention provides a method of producing the medium, in an environmentally compliant and efficient manner, that is compatible with average skills in the art. Sublimation imprinting results in a graphic decoration that is permanently embedded within the surface of the receptive coating. In contrast to prior techniques, the present invention does not require additional layers) to be applied post-sublimation, although caters to the application of such layers if additional protection against excessive ultraviolet exposure or harsh or unusual chemical attack is deemed required or preferred.

The foregoing description of the invention illustrates and describes the present invention. Additionally, the disclosure shows and describes only the preferred embodiments of the invention, but as aforementioned, it is to be understood that the invention is capable of use in various other combinations, modifications, and environments and is capable of changes or modifications within the scope of the inventive concept as expressed herein, commensurate with the above teachings, and/or the skill or knowledge of the relevant art. The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form disclosed herein. Also, it is intended that the appended claims be construed to include alternative embodiments.

I claim:

1. An image receptive medium, comprising:
a substrate;
at least one luminescent visible light producing layer arranged on the substrate; and
an image receiving layer arranged on the light producing layer and operable to receive an image through at least one of sublimation and diffusion.

2. The image receptive medium according to claim 1, wherein the substrate comprises at least one of metal, ceramic, plastic and fibrous material.

3. The image receptive medium according to claim 1, wherein the substrate comprises at least one of aluminum, plastic, porcelain, glass, wood , and paper.

4. The image receptive medium according to claim 1, wherein the light producing layer comprises at least one of a florescent material and a phosphorescent material.

5. The image receptive medium according to claim 4, wherein the light producing layer further comprises a polymer that is at least partially clear after curing.

6. The image receptive material according to claim 5, wherein the polymer comprises polyester.

7. The image receptive material according to claim 5, wherein the florescent material and/or the phosphorescent material and the polymer are mixed at a ratio of about 1:2 to about 1:20 by weight.

8. The image receptive material according to claim 5, wherein the florescent material and or the phosphorescent material and the polymer are mixed at a ratio of about 1:4 by weight.

9. The image receptive material according to claim 5, wherein the florescent material and/or the phosphorescent material and the polymer both comprise powders have substantially similar particle sizes.

10. The image receptive material according to claim 5, wherein the florescent material and the polymer are mixed without extrusion.

11. The image receptive material according to claim 1, wherein the imaging material comprises a plurality of light producing layers.

12. The image receptive material according to claim 11, wherein the imaging material comprises six light producing layers.

13. The image receptive material according to claim 11, wherein each light-producing layer has a thickness of about 0.01 mm to about 10.00 mm.

14. The image receptive material according to claim 12, wherein each light-producing layer has a thickness of about 0.2 mm.

15. The image receptive material according to claim 8, wherein the phosphorescent material comprises an alkaline material.

16. The image receptive material according to claim 15, wherein the alkaline material comprises strontium aluminate.

17. The image receptive material according to claim 16, wherein the phosphorescent material is activated by rare earth ions.

18. The image receptive medium according to claim 1, further comprising:
a base layer between the substrate and the light producing layer, the base layer comprising at least one of a lightly colored and reflective material.

19. The image receptive medium according to claim 18, wherein the base layer is white.

20. The image receptive medium according to claim 18, wherein the substrate has a dark color or has a reflectivity below a threshold value.

21. The image receptive medium according to claim 18, wherein the base layer comprises titanium dioxide.

22. The image receptive medium according to claim 18, further comprising:
a primer layer between the substrate and the base layer.

23. The image receptive medium according to claim 22, wherein the primer layer provides at least function of improving deposition of the base layer, inducing a chemical reaction between the base layer and the substrate during curing, and improving a chemical reaction between the base layer and the substrate during curing.

24. The image receptive medium according to claim 1, wherein the image receiving layer receives dyes by at least one of diffusion and sublimation.

25. The image receptive medium according to claim 1, wherein the image receiving layer is transparent.

26. The image receptive medium according to claim 1, wherein the image receiving layer is translucent.

27. The image receptive medium according to claim 1, wherein the image receiving layer physically and chemically protects the light-producing layer.

28. The image receptive medium according to claim 1, further comprising:
a protective layer arranged on the imaging-receiving layer.

29. The image receptive medium according to claim 28, wherein the protective layer is non-image receiving.

30. The image receptive medium according to claim 1, wherein the material is resistant to chlorine exposure.

31. The image receptive material according to claim 1, wherein the material is resistant to ultraviolet radiation.

32. The image receptive material according to claim 1, further comprising:
a color altering material for altering a color of an image produced on the medium.

33. The image receptive material according to claim 32, wherein the color altering material is incorporated into at least one of the light producing layer and the image-receiving layer.

34. The image receptive material according to claim 32, further comprising:
a color altering layer comprising the color altering material.

35. An imaging system, comprising:
an image receptive medium comprising a substrate, at least one visible light producing layer arranged on the substrate, and an image receiving layer arranged on the light producing layer operable to receive an image through at least one of sublimation and diffusion; and
a transfer medium comprising an image to be transferred to the image receptive medium by at least one of sublimation and diffusion.

36. An imaging system, comprising:
a processor operable to modify an image and to transmit the image to a printer;
a printer operable to receive the image and print the image on a transfer medium; and
a transfer device operable to apply at least one of heat and pressure to the transfer medium and an image receptive medium to effect transfer of the image from the transfer medium to the image receptive medium through at least one of sublimation and diffusion.

37. The method according to claim 36, further comprising:
an image source operable to transmit an image to a processor.

38. A method of making an imaging material, the method comprising:
depositing at least one visible light producing layer arranged on the substrate on a substrate; and
depositing an image receptive layer arranged on the light-producing layer, the image receptive layer being operable to receive an image through at least one of sublimation and diffusion.

39. The method according to claim 38, further comprising:
forming the at least one visible light producing layer by mixing a light producing pigment with a transparent or translucent carrier without extrusion.

40. A process for producing an image on an image receptive medium that includes at least one visible light producing layer and an image receiving layer arranged on the light producing layer and operable to receive an image through at least one of sublimation and diffusion, the process comprising:
altering a digital representation of an image perform at least one compensating for and complementing a hue of visible light produced by the visible light producing layer;
forming the altered image on a transfer medium; and
transferring the image to the image receptive medium.

41. The process according to claim 40, wherein the digital representation is altered to optimize the accuracy of appearance of the image formed on the image receptive medium.
